(19) United States
(12) Patent Application Publication
(10) Pub. No.: US 2002/0038453 A1
(43) Pub. Date: Mar. 28, 2002

(54) Method and system for software optimization

(76) Inventors: Andrew Riddle, Philadelphia, PA (US); Phillip Schanely, Plainsboro, NJ (US)

Correspondence Address: Stephen J. Weed, Synnestvedt & Lechner LLP, 2600 Aramark Tower, 1101 Market Street, Philadelphia, PA, 19107-2950, US

(21) Appl. No.: 09/927,017

(22) Filed: Aug. 9, 2001

Related U.S. Application Data
(60) Provisional application No. 60/223,890, filed on Aug. 9, 2000.
(60) Provisional application No. 60/240,721, filed on Oct. 16, 2000.

(51) Int. Cl. G06F 9/45

(52) U.S. Cl. 717/151

(57) ABSTRACT

A computer program optimization method and computer system, computer program product, and operating system in accordance with the method. The method includes generating a plurality of intermediate software optimizations, evaluating the plurality of intermediate software optimizations, selecting a final software optimization based the evaluation, and transforming the final software optimization into an optimized computer program.

### CROSS-REFERENCE TO RELATED APPLICATIONS

This application is based on, and claims priority to, U.S. Provisional Application Ser. No. 60/223,890, filed Aug. 9, 2000, and U.S. Provisional Application Ser. No. 60/240,721, filed Oct. 16, 2000, both of which are incorporated fully herein by reference.

### FIELD OF THE INVENTION

The present invention relates to computer software and, more particularly, to a method, system, and product for optimizing computer software.

### BACKGROUND OF THE INVENTION

When computer programmers create computer programs, they write source code in a computer programing language (e.g., C++, Visual Basic, Java, etc.). This source code is transformed (i.e., compiled) into executable code by a computer program called a compiler for execution by the operating system of an end-user's computer to provide the functionality of the created computer program to the end user. In addition to creating code which is executable by the end-users's computer, typically, another function of the compilation process is to make the executable code efficient. The process by which the compiler makes the executable code more efficient is called optimization.

Present compilers contain coding substitution libraries of many different coding sequences and equivalent substitutions for the coding sequences that are used to make the resultant executable code more efficient based on an optimization objective (e.g., minimizing execution time or minimizing binary code size). During compiling, if the compiler identifies a coding sequence that is in one of its coding substitution libraries, the compiler substitutes the coding sequence with a more efficient sequence in terms of the optimization objective.

An example of a coding sequence is a coding loop that performs a series of instructions a specified number of times (e.g., three times). During processing, it takes more computer processing time to perform the series of instructions and “jump” to the beginning of the series of instructions to perform the series of instructions a second and a third time, than it takes to perform the series of instruction three times in a row without jumping. Accordingly, if the optimization objective is to minimize execution time, the compiler in the present example would contain an coding substitution library having a coding loop and instructions to repeat the series of instruction within the coding loop a number of times, thereby enabling the compiler to identify the coding loop and substitute the coding loop with three sets of the series of instructions that make up the coding loop in the present example. By substituting three sets of identical instructions for the single coding loop, the resultant executable code created by the compiler becomes more efficient in terms of execution time, however, the resultant executable code becomes less efficient in terms of code size.

In conventional compilers, every time a coding sequence within a coding substitution library is identified, the coding sequence is substituted with equivalent code. A typical computer program contains many coding sequences. For example, a computer program may have a coding loop containing a large number of steps to be executed 1,000 times followed by another coding loop containing a few steps to be executed three times. Always performing substitutions when a coding sequence from a coding substitution library is identified, however, may produce undesirable results. If a coding loop contains a large number of steps to be executed 1,000 times, and is substituted with equivalent code, the resultant executable code created by the compiler incorporating the substitution becomes very inefficient in terms of code size. In this scenario, the inefficiency in terms of code size may outweigh the efficiency gained in terms of execution time. On the other hand, if a coding loop contains a small number of steps to be performed three times, and is substituted with equivalent code, the efficiency in terms of execution time may outweigh the inefficiency in terms of code size after the substitution. Therefore, it may be desirable to perform the substitution for the loop that is performed three times and not perform the substitution for the loop that is performed 1,000 times. Conventional compilers are unable to evaluate the effect of making some or all of the substitutions based on competing optimization objectives and, therefore, are unable to selectively determine when to make a coding substitution.

Accordingly, there is a need for software optimization methods, systems, and products capable of evaluating the effect of coding substitutions on the resultant executable code and applying coding substitutions to create the resultant executable code based on the evaluation. The present invention fulfills this need among others.

### SUMMARY OF THE INVENTION

The present invention provides for a method, system, and product which overcomes the aforementioned problems by generating a plurality of software optimization scenarios from a computer program and evaluating each scenario to select a final software optimization based on one or more optimization objectives to create an optimized computer program.

The optimization method of the present invention differs substantially from conventional optimizers that generate a single intermediate representation of the computer program (e.g., a single graph), apply all applicable coding substitutions to the single intermediate representation to obtain a resultant software representation, and transform the resultant software representation into an optimized computer program. The present invention introduces the novel concept of generating a plurality of intermediate software optimizations reflecting the computer program with zero or more coding substitutions, evaluating each of the intermediate software optimizations, and selecting the intermediate software optimization with the highest evaluation to create the optimized computer program. This novel optimization method is able to take into account the effect of applying one or more coding substitutions to the computer program to create the optimized computer program, rather than simply applying all coding substitutions as in conventional optimizers.

One aspect of the present invention is a method for optimizing a computer program including generating a plurality of intermediate software optimizations based on the computer program, evaluating each of the plurality of intermediate software optimizations based on at least one optimization objective, selecting a final software optimization from the plurality of intermediate software optimizations based on results of the evaluating step, and transforming the final software optimization into an optimized computer program.

In addition, the present invention encompasses a computer system, computer program product, and operating system for carrying out the inventive method.

### BRIEF DESCRIPTION OF THE DRAWINGS

FIG. 1 is a flowchart of an computer program optimization method in accordance with the present invention;

FIG. 1A is a flowchart of a method for generating the intermediate software optimizations of FIG. 1; and

FIG. 2 is a block diagram of a processing device in which the present invention may be practiced.

### DETAILED DESCRIPTION OF THE INVENTION

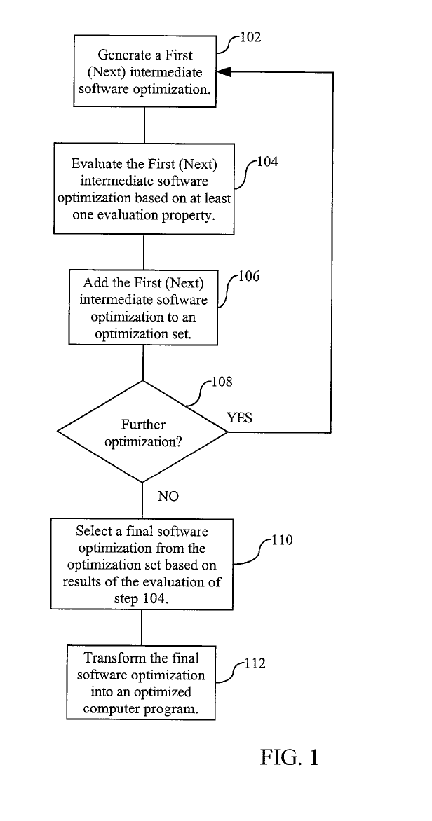

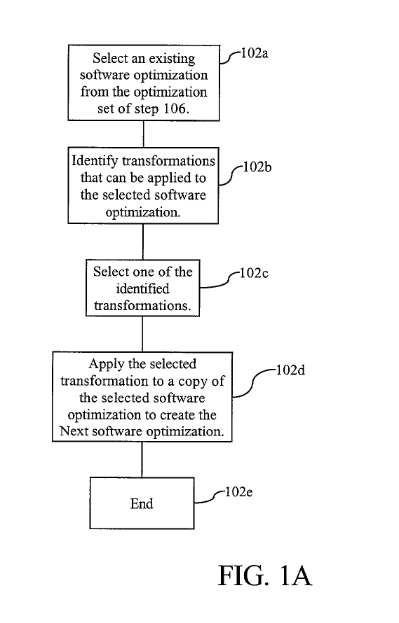

FIG. 1 depicts a computer program optimization flow chart 100 illustrating a preferred method for optimizing a computer program created in a conventional programing language by a computer programmer. Generally, the method comprises generating intermediate software optimizations based on the computer program, evaluating the intermediate software optimizations based on at least one optimization objective, selecting a final software optimization based on results of the evaluating step, and transforming the final software optimization into an optimized computer program. The preferred method will be described in detail in the following paragraphs.

At step 102, intermediate software optimizations are generated from a computer program to be optimized. Each of the intermediate software optimizations reflect the computer program as modified by zero or more coding substitutions. In the preferred method, the first intermediate software optimization reflects the computer program without any coding substitutions being applied. After the first intermediate software optimization is generated, additional intermediate software optimizations that reflect the computer program with various coding substitutions being applied are generated according to the steps depicted in FIG. 1A below.

In a preferred embodiment, the intermediate software optimizations are graphs, referred to herein as software optimization graphs. Graphs are a mathematical tool used commonly for modeling computer programs. In a preferred embodiment, individual instructions within the computer program are represented in a software optimization graph by “vertices” and interconnections between the instructions are represented by “edges.” An instruction that is represented by a vertex will be connected to other vertices that represent instructions to be executed immediately before or after the instruction via the edges. The edges contain unique identifiers that allow connected instructions to be associated with one another within the graph. The graph can be depicted pictorially, however, the number of instructions in a typical computer program and the interconnections between the instructions make it impractical to display the graphical representation of the computer program pictorially.

The first software optimization graph is generated in a known manner by substituting instructions within the computer program with binary code and parsing the binary code to create a software representation graph that reflects the computer program before any coding substitutions are applied. In the preferred embodiment, the binary code is parsed by creating a vertex for each instruction within the binary code and, then, associating the instructions via edges to every instruction that may be executed immediately before or after the execution of a particular instruction.

At step 104, the intermediate software optimization of step 102 is evaluated based on at least one optimization objective. An evaluation function is used to evaluate the intermediate software optimization based on selected optimization objectives. The evaluation of the intermediate software optimization provides a guide for comparing an optimized computer program which would be based on the intermediate software optimization being evaluated with optimized computer programs which would be based on other intermediate software optimizations.

In a preferred embodiment, the intermediate software optimization may be evaluated based on more that one optimization objective. For example, the evaluation may be based on the optimization objectives of minimizing execution time while minimizing code size. In a preferred embodiment, the evaluation function generates a single number. Each of the optimization objectives may be weighted to emphasize the importance of one objective over another. In an alternative embodiment, separate values are determined for each objective and the weight of each optimization objective is determined by the selection process in step 110. The optimization objectives may be predetermined or may be supplied by an operator using conventional input devices.

The optimization objectives include, but are not limited to, minimizing execution time, minimizing code size, predetermined code size parameters, and minimizing runtime memory consumption. In the preferred embodiment, the intermediate software optimization is a software optimization graph. Evaluation functions for evaluating software optimization graphs based on selected optimization objectives would be readily apparent to those skilled in the art. Example evaluation functions for evaluating a software optimization graph to minimize execution time and code size, respectively, are described below.

To evaluate the execution time of a computer program based on a software optimization graph, first, the execution time is determined. The software optimization graph is then evaluated based on the execution time, with shorter execution times resulting in higher evaluations. To determine the execution time of a computer program from a software optimization graph, first, the execution time for each instruction in the software optimization graph is estimated. Next, the number of times each instruction will be executed is estimated. The execution time is then determined by multiplying the execution time for each instruction by the number of times the instruction will be executed to determine an instruction execution time and summing the instruction execution times for every instruction within the software optimization graph.

In a preferred embodiment the number of times each instruction is executed is determined using a known “profiling” technique. To profile a computer program, the computer program is run a number of times using different parameters for each run. The number of times each instruction is executed during each run is tracked and averaged to obtain an estimate of the number of times each instruction is executed.

To evaluate the code size of a computer program based on a software optimization graph, first, the code size is determined. The software optimization graph is then evaluated based on the code size with smaller code sizes resulting in higher evaluations. The code size is determined by, first, estimating the code size of an instruction and multiplying the code size by the number of times the instruction appears in the code for each instruction in the software optimization graph to determine an instruction code size and, then, summing the instruction code sizes for every instruction in the software optimization graph.

At step 106, the intermediate software optimization is added to an optimization set. The optimization set is a set of intermediate software optimizations. Each time an intermediate software optimization is generated it is added to the optimization set.

At step 108, a decision regarding further optimization is made. The decision is preferably based on the lapsing of a predetermined period of time (e.g., ten minutes, two weeks). For example, further optimization will not be performed after the optimization method of the present invention has executed for a period of ten minutes. In an alternative embodiment, an operator determines whether further optimization is needed. In other embodiments, optimization is discontinued after a specified number of intermediate software optimization have been generated or a predetermined evaluation is achieved.

If further optimization is performed, processing is resumed at step 102. In steps 102-108, the next intermediate software optimization is generated, evaluated, and added to the optimization set. Conceptually, steps 102 through 108 function together to generate a plurality of intermediate software optimizations and evaluate each of the plurality of intermediate software optimizations based on at least one optimization objective. The next intermediate software optimization is generated according to the steps depicted in the flowchart of FIG. 1A described below. If further optimization is not performed, processing proceeds to step 110.

FIG. 1A depicts the steps involved in generating the next intermediate software optimization of step 102 (FIG. 1). At step 102a, an existing one of the intermediate software optimizations from the optimization set of step 106 (FIG. 1) is selected. The selection of the intermediate software optimization is made by a search algorithm. In a preferred embodiment, the intermediate software optimization is a software optimization graph and the search algorithm is a simulated annealing search algorithm. A description of a simulated annealing search algorithm is described in Stuart Russel and Peter Norvig, Artificial Intelligence: A Modem Approach (Prentice-Hall, 1995), incorporated fully herein by reference.

At step 102b, known coding substitutions are identified that can be applied to the selected intermediate software optimization. In a preferred embodiment the selected intermediate software optimization is a software optimization graph and coding substitutions are identified that can be applied to portions of the software optimization graph (i.e., sub-graphs) that represent associated instructions (i.e., vertices). For example, if the software optimization graph contains a sub-graph of instructions for performing a loop and another sub-graph of instructions for performing a calculation with fixed value numbers, a loop coding substitution and a fixed value coding substitution (i.e., a coding substitution replacing a fixed calculation with a result) would be identified for the sub-graphs, respectively.

At step 102c, one of the identified coding substitutions is selected using a searching algorithm. For example, if a loop coding substitution and a fixed value coding substitution are identified in step 102b, a searching algorithm selects either the loop coding substitution or the fixed value coding substitution. In a preferred embodiment, the searching algorithm is a simulated annealing search algorithm as described above.

At step 102d, the selected coding substitution is applied to a copy of the selected intermediate software optimization to create a new intermediate software optimization. For example, if the searching algorithm selects the fixed value coding substitution in step 102c, a copy of the selected intermediate software optimization is made and the fixed value coding substitution is performed on the copy to create the next intermediate software optimization of step 102 (FIG. 1). The coding substitution is applied to a copy of the selected intermediate software optimization so that the original selected intermediate software optimization is maintained in the optimization set of step 106 (FIG. 1) so that it may be selected at a later time in step 102a. At step 102e, processing ends.

In a preferred embodiment, the selected intermediate software optimization is a software optimization graph and a copy of the selected software optimization graph is made. The coding substitution is then applied to the copy by disconnecting the edges of the vertices of the sub-graph containing the code to be replaced, inserting the coding substitution, and connecting the edges of the vertices that define the coding substitution.

At step 110, a final software optimization is selected from the plurality of intermediate software optimizations based on results of the evaluating step 106. In a preferred embodiment, each intermediate software optimization is assigned a single evaluation in step 104 and the intermediate software optimization with the highest evaluation is selected. In an alternative embodiment, the evaluation step assigns different evaluations for different optimization objectives and the selection process of step 110 involves assigning weights to the evaluations associated with the different optimization objectives to select the final software optimization.

At step 112, the final software optimization is transformed into an optimized computer program. The software optimization is transformed into the optimized computer program in a known manner such as through the use of a search algorithm. In a preferred embodiment, the final software optimization is a software optimization graph. In the preferred embodiment, initially, an empty binary list is created. For every vertex in the final software optimization graph, the data associated with the vertex is inserted into the binary list. The data within the list is then ordered in a known manner that maximizes the number of instructions associated with vertices that may be executed in sequence and can be positioned sequentially in the binary list. The binary list is then output as binary code to derive the optimized computer program.

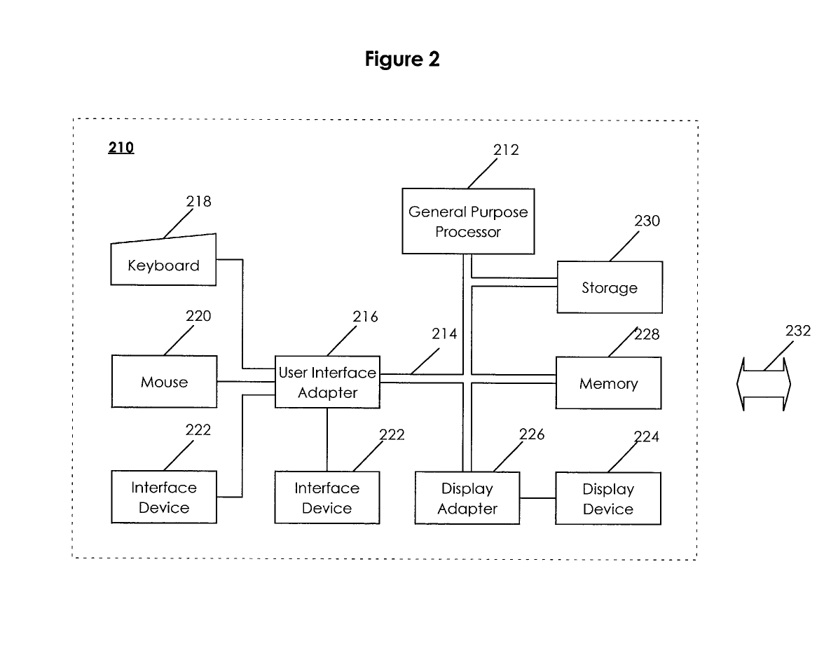

FIG. 2 is a block diagram of a processing device 210 for practicing the present invention. This block diagram represents hardware for a local implementation or a remote implementation. As is well known in the art, the workstation of FIG. 2 includes a representative processing device, e.g. a single user computer workstation 210, such as a personal computer, including related peripheral devices. The workstation 210 includes a general purpose microprocessor 212 and a bus 214 employed to connect and enable communication between the microprocessor 212 and the components of the workstation 210 in accordance with known techniques. The workstation 210 typically includes a user interface adapter 216, which connects the microprocessor 212 via the bus 214 to one or more interface devices, such as a keyboard 218, mouse 220, and/or other interface devices 222, which can be any user interface device, such as a touch sensitive screen, digitized entry pad, etc. The bus 214 also connects a display device 224, such as an LCD screen or monitor, to the microprocessor 212 via a display adapter 226. The bus 214 also connects the microprocessor 212 to memory 228 and long-term storage 230 (collectively, “memory”) which can include a hard drive, diskette drive, tape drive, etc.

The workstation 210 may communicate with other computers or networks of computers, for example, via a communications channel or modem 232. Alternatively, the workstation 210 may communicate using a wireless interface at 232. The workstation 210 may be associated with such other computers in a LAN or a wide area network (WAN), or the workstation 210 can be a client in a client/server arrangement with another computer, etc. All of these configurations, as well as the appropriate communications hardware and software, are known in the art.

An example of an implementation of the present invention is described below. The example examines a simple Java computer program, the bytecode produced from a Java compiler, and the optimized computed program that results from applying the method of the present invention. The example assumes an understanding of Java bytecode. The computer program to be optimized is the Java program:

public static void main(String[] argv) {
int numberOfArgs = argv.length;
if (numberOfArgs > 0) {
System.out.println(“I got some arguments.”);
} else {
System.out.println(“I did not get any arguments.”);
}
}

The Java bytecode produced from this Java program (i.e., source code) is the first intermediate software optimization of the present invention. A listing of the Java bytecode follows (this is the bytecode generated from Sun's java compiler in the Java 2 SDK v1.3):

01 aload_{—}0

02 arraylength

03 istore_{—}1

04 iload_{—}1

05 ifle LABEL1

06 getstatic <Field java.io.PrintStream out>

07 ldc <String “I got some arguments.”>

08 invokevirtual <Method void println(java.lang.String)>

09 goto LABEL2

LABEL1:

10 getstatic <Field java.io.PrintStream out>

11 ldc <String “I did not get any arguments.”>

12 invokevirtual <Method void println(java.lang.String)>

LABEL2:

13 return

A series of coding substitutions are applied to this bytecode. Although the bytecode is shown in a linear format, in a preferred embodiment, the coding substitutions actually happen in a code-flow graph (e.g., software optimization graph) corresponding to these instructions.

Using a “simulated annealing” searching algorithm for this example, new coding substitutions are applied to the most recently generated graph. The “simulated annealing” algorithm will normally choose the coding substitutions most likely to improve the graph's evaluation, but will choose, with some small probability, a random coding substitutions. This is done to avoid the problem of getting caught in a local maximum. A small subset of the actual coding substitution library is used in this example to simplify the coding substitution selection. The coding substitution library for the present example, consisting of six coding substitutions, follows:

1)

store_X

load_X

is substituted with

dup

store_X

2)

Y (Y is a push instruction)

if L

X

. . .

L:

X

. . .

is substituted with

X

Y (Y is a push instruction)

if L

. . .

L:

. . .

3)

X

goto L

. . .

X

L:

is substituted with

goto L

. . .

L:

X

4)

storeX (X is not loaded)

is substituted with

pop

5)

dup

pop

is substituted with

<nothing>

6)

X1

X2

X3

Y

(where X1, X2, and X3 executed together leave the stack unchanged and their behavior does not depend upon any value in the stack) is substituted with

Y

X1

X2

X3

Assuming that the optimization objective is to reduce code size, the evaluation function is any inverse function of the code size. In the present example, the initial program is 30 bytes long.

The first intermediate software optimization matches coding substitutions 1, 2, and 3. Normally, the searching algorithm selects a coding substitution that is most likely to improve the evaluation. Both coding substitutions 2 and 3 are equally likely to improve the evaluation, so one of them is selected at random, e.g., coding substitution 2. After the application of coding substitution 2, a new intermediate software optimization is created which follows:

01 aload_{—}0

02 arraylength

03 istore_{—}1

06 getstatic <Field java.io.PrintStream out>

04 iload_{—}1

05 ifle LABEL1

07 ldc <String “I got some arguments.”>

08 invokevirtual <Method void println(java.lang.String)>

09 goto LABEL2

LABEL1:

11 ldc <String “I did not get any arguments.”>

08 invokevirtual <Method void println(java.lang.String)>

LABEL2:

13 return

size: 27 bytes

The new intermediate software optimization matches coding substitutions 3 and 6. Coding substitution 3 is the most likely to improve the evaluation; however, let us assume that the search algorithm here has selected a coding substitution at random, e.g., coding substitution 6.

01 getstatic <Field java.io.PrintStream out>

02 aload_{—}0

03 arraylength

04 istore_{—}1

05 iload_{—}1

06 ifle LABEL1

07 ldc <String “I got some arguments.”>

08 invokevirtual <Method void println(java.lang.String)>

09 goto LABEL2

LABEL1:

10 ldc <String “I did not get any arguments.”>

11 invokevirtual <Method void println(java.lang.String)>

LABEL2:

12 return

size: 27 bytes

This new intermediate software optimization matches coding substitutions 1 and 3. Coding substitution 3 is most likely to improve the evaluation, so it is selected.

01 getstatic <Field java.io.PrintStream out>

02 aload_{—}0

03 arraylength

04 istore_{—}1

05 iload_{—}1

06 ifle LABEL1

07 ldc <String “I got some arguments.”>

08 goto LABEL2

LABEL1:

09 ldc <String “I did not get any arguments.”>

LABEL2:

10 invokevirtual <Method void println(java.lang.String)>

11 return

size: 24 bytes

The new intermediate software optimization matches only coding substitution 1, so that coding substitution is selected.

01 getstatic <Field java.io.PrintStream out>

02 aload_{—}0

03 arraylength

04 dup

05 istore_{—}1

06 ifle LABEL1

07 ldc <String “I got some arguments.”>

08 goto LABEL2

LABEL1:

09 ldc <String “I did not get any arguments.”>

LABEL2:

10 invokevirtual <Method void println(java.lang.String)>

11 return

size: 24 bytes

The new intermediate software optimization matches only coding substitution 4, so that coding substitution is selected.

01 getstatic <Field java.io.PrintStream out>

02 aload_{—}0

03 arraylength

04 dup

05 pop

06 ifle LABEL1

07 ldc <String “I got some arguments.”>

08 goto LABEL2

LABEL1:

09 ldc <String “I did not get any arguments.”>

LABEL2:

10 invokevirtual <Method void println(java.lang.String)>

11 return

size: 24 bytes

The new intermediate software optimization matches only coding substitution 5, so that coding substitution is selected.

01 getstatic <Field java.io.PrintStream out>

02 aload_{—}0

03 arraylength

04 ifle LABEL1

05 ldc <String “I got some arguments.”>

06 goto LABEL2

LABEL1:

07 ldc <String “I did not get any arguments.”>

LABEL2:

08 invokevirtual <Method void println(java.lang.String)>

09 return

size: 21 bytes

No coding substitutions match this intermediate software optimization, so the optimization is finished. (The actual coding substitution library is much larger, and it is unlikely that it will run out of coding substitutions to apply; instead, optimization stops after a specified amount of time or at the discretion of the user.)

The intermediate software optimization generated last has the least number of bytes (i.e., 21 bytes) and, therefore, will receive the best evaluation. Accordingly, the last software optimization is selected as the final software optimization for transformation into the optimized computer program.

Having thus described a few particular embodiments of the invention, various alterations, modifications, and improvements will readily occur to those skilled in the art. For example, the optimization method may be implemented as a “stand-alone” computer program or may be implemented in another computer program such as an operating system. In addition, the optimization method may be applied to individual computer programs or may be applied to a group of programs simultaneously. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for optimizing a computer program, said method comprising the steps of:
generating a plurality of intermediate software optimizations based on the computer program;
evaluating each of said plurality of intermediate software optimizations based on at least one optimization objective;
selecting a final software optimization from said plurality of intermediate software optimizations based on results of said evaluating step; and
transforming said final software optimization into an optimized computer program.

2. The method of claim 1, wherein said plurality of intermediate software optimizations are software optimization graphs.

3. The method of claim 2, wherein said generating step comprises the steps of:
substituting instructions of the computer program with binary code;
parsing said binary code into a software representation graph; and
generating said plurality of software optimization graphs based on said software representation graph.

4. The method of claim 3, wherein said generating step comprises the steps of:
selecting an existing software optimization graph from said plurality of software optimization graphs;
identifying coding substitutions to apply to said existing software optimization graph;
selecting one of said identified coding substitutions; and
applying said selected one of said identified coding substitutions to a copy of said selected existing software optimization graph to create a new software optimization graph.

5. The method of claim 1, wherein said generating step comprises the steps of:
selecting an existing intermediate software optimization from said plurality of intermediate software optimizations;
identifying coding substitutions to apply to said existing intermediate software optimization;
selecting one of said identified coding substitutions; and
applying said selected one of said identified coding substitutions to a copy of said selected existing intermediate software optimization to create a new intermediate software optimization.

6. The method of claim 5, wherein said selecting steps each comprise the step of applying a searching algorithm.

7. The method of claim 1, wherein said evaluating step comprises the step of:
receiving said at least one optimization objective from an operator.

8. The method of claim 1, wherein said at least one optimization objective is one or more optimization objectives selected from a group consisting of minimizing execution time, minimizing code size, and minimizing runtime memory consumption.

9. The method of claim 1, wherein said selecting step comprises selecting the intermediate software optimization from said plurality of intermediate software optimizations having the highest evaluation.

10. A computer system for optimizing a computer program, said computer system comprising:
means for generating a plurality of intermediate software optimizations based on the computer program;
means for evaluating each of said plurality of intermediate software optimizations based on at least one optimization objective;
means for selecting a final software optimization from said plurality of intermediate software optimizations based on results of said evaluating step; and
means for transforming said final software optimization into an optimized computer program.

11. The computer system of claim 10, said generating means comprising at least:
means for selecting an existing intermediate software optimization from said plurality of intermediate software optimizations;
means for identifying coding substitutions to apply to said existing intermediate software optimization;
means for selecting one of said identified coding substitutions; and
means for applying said selected one of said identified coding substitutions to a copy of said selected existing intermediate software optimization to create a new intermediate software optimization.

12. A computer program product for optimizing a computer program, said computer program product comprising:
computer readable program code embodied in a computer readable medium, the computer readable program code comprising at least:
computer readable program code for generating a plurality of intermediate software optimizations based on the computer program;
computer readable program code for evaluating each of said plurality of intermediate software optimizations based on at least one optimization objective;
computer readable program code for selecting a final software optimization from said plurality of intermediate software optimizations based on results of said evaluating step; and
computer readable program code for transforming said final software optimization into an optimized computer program.

13. The computer program product of claim 12, said generating computer readable program code comprising at least:
computer readable program code for selecting an existing intermediate software optimization from said plurality of intermediate software optimizations;
computer readable program code for identifying coding substitutions to apply to said existing intermediate software optimization;
computer readable program code for selecting one of said identified coding substitutions; and
computer readable program code for applying said selected one of said identified coding substitutions to a copy of said selected existing intermediate software optimization to create a new intermediate software optimization.

14. An operating system capable of optimizing a computer program, said operating system comprising:
program code for generating a plurality of intermediate software optimizations based on the computer program;
program code for evaluating each of said plurality of intermediate software optimizations based on at least one optimization objective;
program code for selecting a final software optimization from said plurality of intermediate software optimizations based on results of said evaluating step; and
program code for transforming said final software optimization into an optimized computer program.

15. The operating system of claim 14, said generating program code comprising at least:
program code for selecting an existing intermediate software optimization from said plurality of intermediate software optimizations;
program code for identifying coding substitutions to apply to said existing intermediate software optimization;
program code for selecting one of said identified coding substitutions; and
program code for applying said selected one of said identified coding substitutions to a copy of said selected existing intermediate software optimization to create a new intermediate software optimization.
